(19) United States
(12) Patent Application Publication
(10) Pub. No.: US 2015/0025569 A1
(43) Pub. Date: Jan. 22, 2015

(54) Auricular Point Stimulus Device

(71) Applicant: ZAN QUAN TECHNOLOGY CO., LTD., Taipei City (TW)

(72) Inventors: Kai-Li Wang, Taipei City (TW); Chung-Yuan Wang, Taipei City (TW)

(21) Appl. No.: 14/332,388

(22) Filed: Jul. 16, 2014

(30) Foreign Application Priority Data
Jul. 18, 2013 (TW) 102213623

(51) Int. Cl. A61H 39/04

(52) U.S. Cl. CPC A61H 39/04; A61H 2201/165; A61H 2205/027
USPC 606/204

(57) ABSTRACT

The present invention provides an auricular point stimulus device, which includes a plate body. The plate body includes a plurality of bead protrusions formed thereon. The plate body has a surface on which a projecting plug or an ear clip is formed. The plate body and the plug are made of an elastically deformable material. The auricular point stimulus device is positionable in an external acoustic meatus or at an opening of the external acoustic meatus with the bead protrusions of the plate body contacting the portions of an auricle that corresponding to heart and lung acupuncture points to simulate the acupuncture points thereby activating, in a long term, the blood circulation of the heart and the lungs and improving the cardiorespiratory fitness of the user.

### TECHNICAL FIELD OF THE INVENTION

The present invention generally relates to an auricular point stimulus device, and more particularly to an auricular point stimulus device that stimulates heart-related or lung-related acupuncture points in the auricle.

### DESCRIPTION OF THE PRIOR ART

Cardiorespiratory fitness, which is also referred to as cardiorespiratory endurance, is the capability that the lungs and heart of an individual to acquire oxygen from air and carry oxygen to tissue cells for use. The cardiorespiratory fitness is an indication of the aerobic capacity of the lungs, the heart, the vessels, and the tissue cells of a person. The importance of improving cardiorespiratory fitting is that the endurance of the lungs and the heart can be improved to make the body persistent longer in doing exercise and not getting tired quickly, and also allowing people to work for longer time and more efficiently. (This information is available from a website of Sports Administration, Ministry of Education, http://www.fitness.org.two/direct02.php).

Ear acupuncture therapy is a method that simulates auricular points through acupuncture or otherwise for disease prevention. The operation is easy and the effect can be obtained quickly. According to the theory of acupuncture meridian, the twelve standard meridians are all directly linked to the ears. When a human body is affected by a disease, a response point appears at a corresponding point on the auricle. The most important concern for ear acupuncture is to find out the point corresponding to the lesion or disease portion. For example, for joint pain, the lesion area or the adrenal gland area may be taken; for waist pain, the lumbar, kidney, or bladder may be taken; for stomachache, stomach, small intestine, liver, or spleen may be taken; for dysmenorrhea, ovary, kidney, or internal secretion may be taken; and for high blood pressure, adrenal gland, liver, kidney, or lower zone of dermal layer may be taken.

Thus, simulation of the auricular acupuncture points corresponding to the body organs may achieve an effect of preventing diseases of the organs. Referring to FIG. 1, among the various acupuncture points located on the auricle 10, the heart acupuncture point 11 and the lung acupuncture point 12 that correspond to the heart and the lungs are located at the site of cavum concha 14 and at a location neighboring the cavum concha 14, the cymba concha 15 is located and may provide an effect of supporting and holding. In view of the entire auricle 10, the portion of the cavum concha 14 is a relatively flat area that is good for deposition of an auricular point stimulus thereon to provide an effect of simulation that is applied to simulate the heart acupuncture point 11 and the lung acupuncture point 12 to improve the cardiorespiratory endurance and to allow for easy operation by a user.

### SUMMARY OF THE INVENTION

The primary object of the present invention is to improve the cardiorespiratory fitness of a user by stimulating the acupuncture points located in the auricle and corresponding to the heart and the lungs.

Another object of the present invention is to provide an auricular point stimulus having a retention structure that allows a user to wear for a long time to simulate the acupuncture points within the auricle corresponding to the heart and the lungs in order to achieve an affect of activating, in a long term, the functions of the heart and the lungs.

To achieve the above objects, the features of improvement of the present invention are that it comprises at least one plate body. The plate body comprises a plurality of bead protrusions formed and distributed thereon. The plate body is made of an elastically deformable material and is directly insertable into an external acoustic meatus or deposited at an opening of the external acoustic meatus with the bead protrusions of the plate body in contact engagement with the corresponding heart and lung acupuncture points of the auricle to constantly stimulate the acupuncture points so as to activate, in a long term, the blood circulation of the heart and the lungs thereby improving the cardiorespiratory fitness of a user. Further, the plate body may comprise a plug or an ear clip integrally formed therewith and may take advantage of the plug or the ear clip to achieve an additional effect of retention and holding, or alternatively both the plug and the ear clip are simultaneously provided so as to achieve dual effects of assisting retention. The plate body can be mounted to a single-ear hanger frame or a head-wearing hanger frame, so that through assistance provided by the single-ear hanger frame and the head-wearing hanger frame, the auricular point stimulus device can be worn for a long term. And, through the single-ear hanger frame and the head-wearing hanger frame applying a force to the auricular point stimulus device, the bead protrusions of the plate body may generate a tender pushing force against the heart and lung acupuncture points to make the result of stimulation bettered.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the acupuncture points within an auricle that correspond to the heart and the lungs.

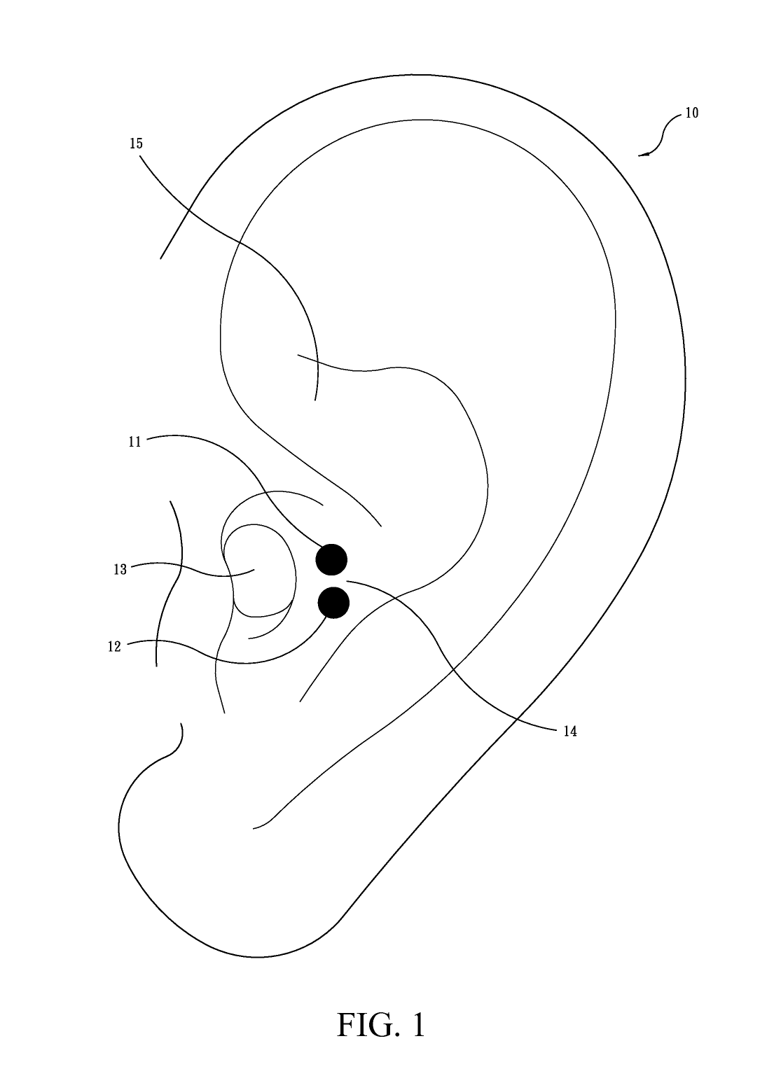

FIG. 2 is a perspective view of the present invention.

FIG. 3 is a schematic view illustrating the use of the present invention.

FIG. 4 is an exploded view showing a second embodiment of the present invention.

FIG. 5 is an exploded view showing a third embodiment of the present invention.

FIG. 6 is a perspective view of FIG. 5 in an assembled form.

FIG. 7 is an exploded view showing a fourth embodiment of the present invention.

FIG. 8 is a perspective view of FIG. 7 in an assembled form.

FIG. 9 is a perspective view showing a fifth embodiment of the present invention.

FIG. 10 is a perspective view showing a sixth embodiment of the present invention.

FIG. 11 is a perspective view showing a seventh embodiment of the present invention.

FIG. 12 is a perspective view showing an eighth embodiment of the present invention.

FIG. 13 is a perspective view showing a ninth embodiment of the present invention.

FIG. 14 is a schematic view illustrating the use of the ninth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

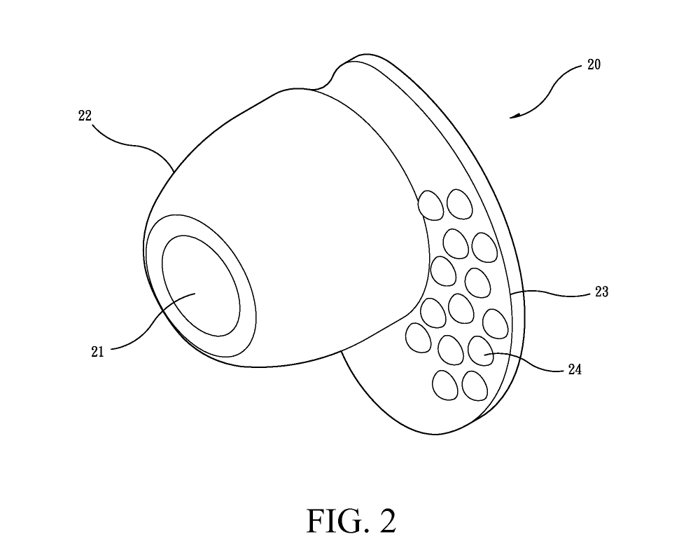

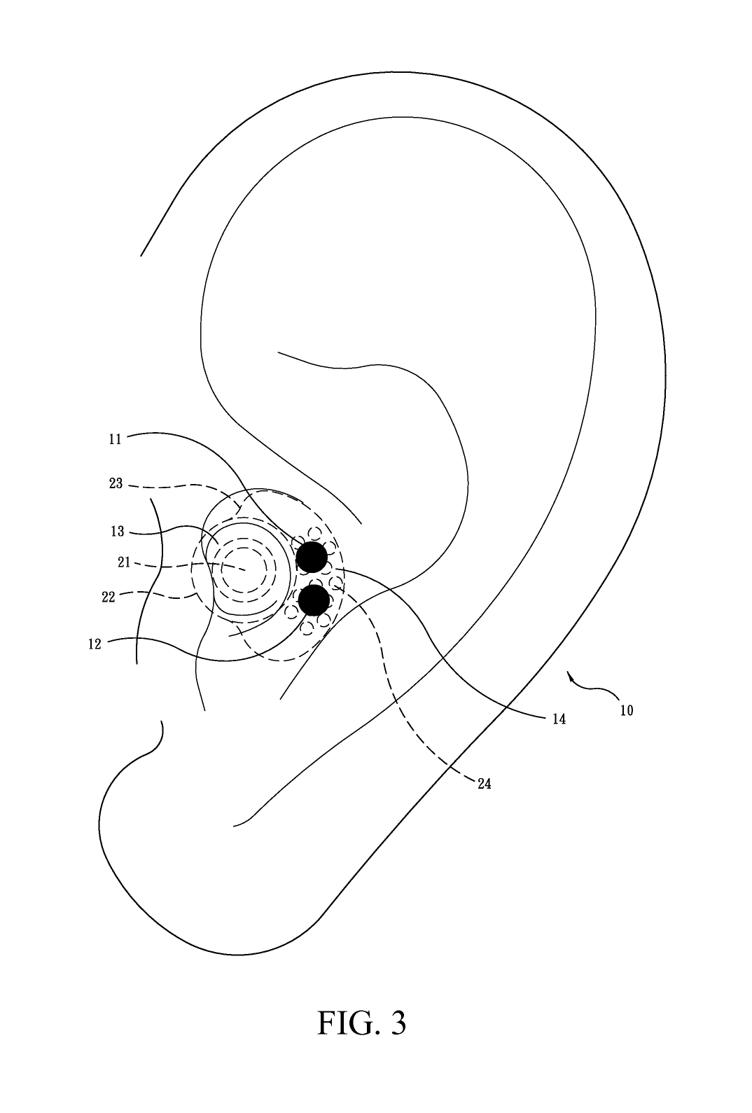

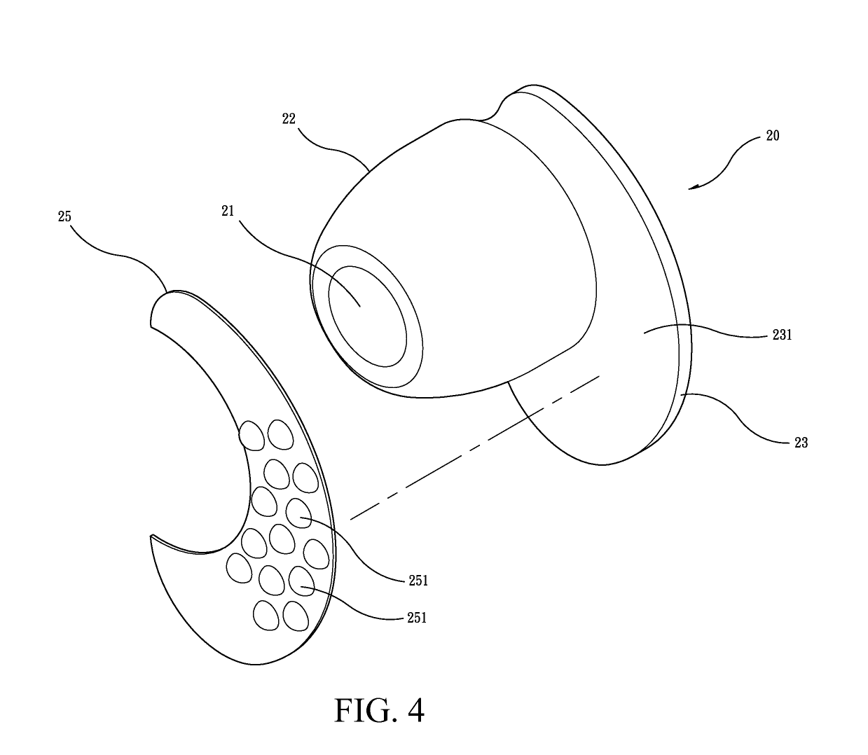

Referring to FIGS. 2 and 3, an auricular point stimulus device 20 according to the instant embodiment is made of an elastically deformable material, where the elastically deformable material may include plastics, rubbers, and silicone rubbers, and at least comprises a plate body 23, where the plate body 23 has a surface on which a raised plug 22 is formed. The plug 22 comprises a through hole 21 extending through opposite ends thereof The plate body 23 comprises a plurality of bead protrusions 24 formed on the surface thereof on which the plug 22 is provided. The plug 22, the plate body 23, and the bead protrusions 24 can be formed integrally together or alternatively, as shown in FIG. 4, the plurality of bead protrusions 251 is provided on a medium that is formed as an adhesive sheet 2 and the adhesive sheet 25 is adhered to an outside surface 231 of the plate body 23.

Continuously referring to FIG. 3, the auricular point stimulus device 20 of the instant embodiment allows the plug 22 to be fit into the external acoustic meatus 13 or deposited in the opening of the external acoustic meatus so as to fix the auricular point stimulus device 20 and to have the plate body 23 positioned against the cavum conchal 14, whereby the plurality of bead protrusions 24 contacts the heart acupuncture point 11 and the lung acupuncture point 12 to achieve an effect of stimulating the heart acupuncture point 11 and the lung acupuncture point 12. Further, the distribution area of the plurality of bead protrusions 24 is made larger than the site where the heart acupuncture point 11 and the lung acupuncture point 12 are located in order to accommodate different users. When a user wears the auricular point stimulus device 20 of the instant embodiment, the heart acupuncture point 11 and the lung acupuncture point are both simulated by the bead protrusions 24 so as to activate, in a long term, the blood circulation of the heart and the lungs thereby improving the cardiorespiratory fitness of the user.

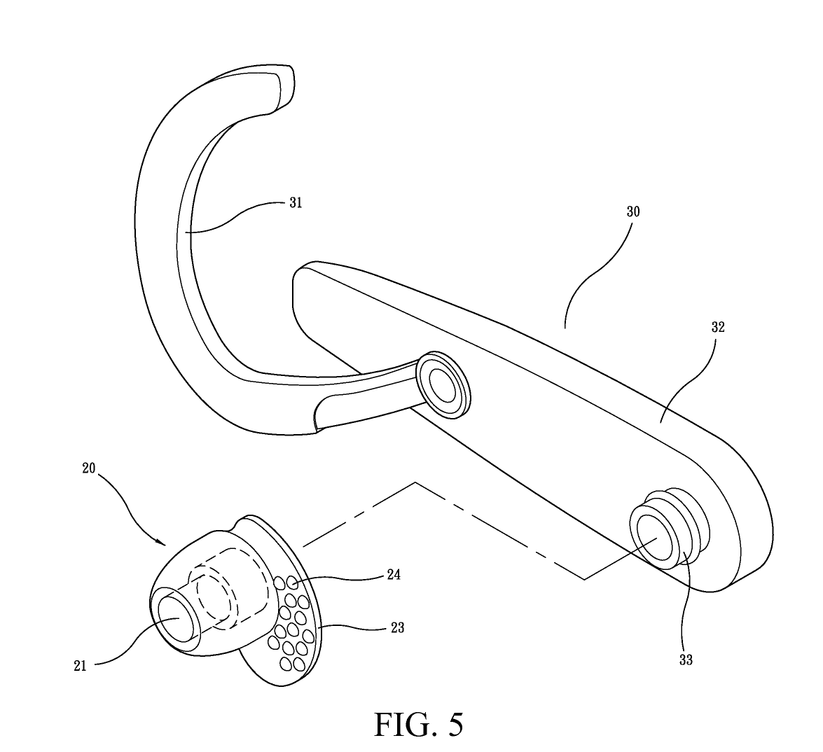

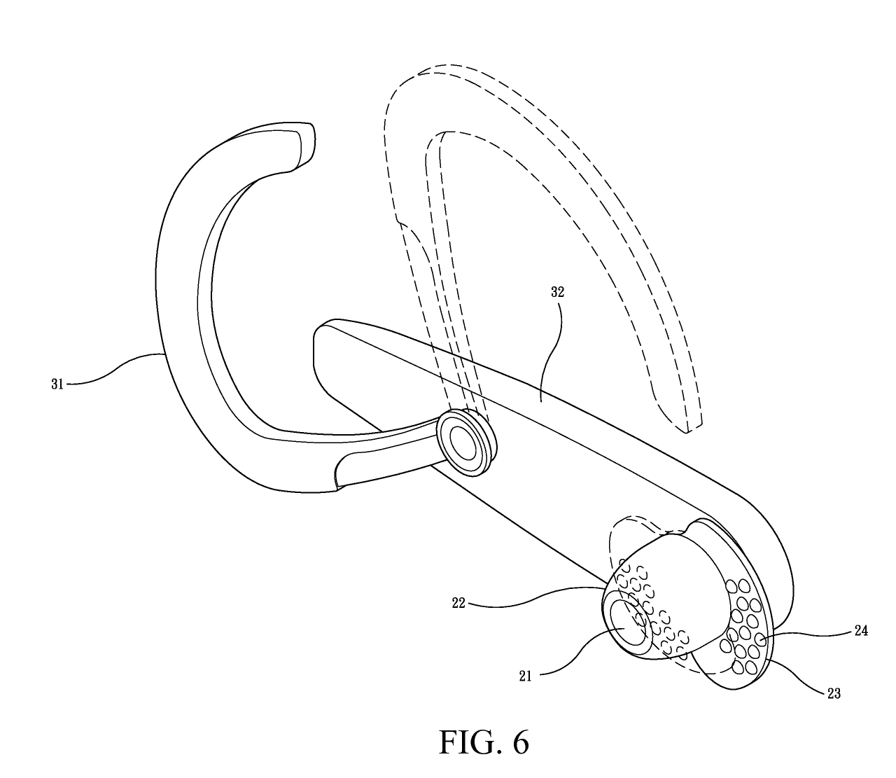

Referring to FIGS. 5 and 6, a third embodiment according to the present invention is shown, where the auricular point stimulus device 20 is arranged on a single-ear hanger frame 30, so that the auricular point stimulus device 20 does not get falling due to the activity and movement of the user. The single-ear hanger frame 30 comprises a helix section 31 that is substantially arc in shape and a coupling section 32. The coupling section 32 has an end rotatably coupled to the helix section 31 so that the helix section 31 or the coupling section is allowed to swing back and forth. The coupling section 32 has an oppose end on which a projecting axle 33 is formed. The axle 33 insertable into the through hole 21 of the plug 22 so as to combine the auricular point stimulus device 20 with the single-ear hanger frame 30 and the auricular point stimulus device 20 is allowed to rotate about the axle 33. The helix section 31 can be hooked to an ear helix of a user and the coupling section 32 can be adjusted to have the plug 22 of the auricular point stimulus device 20 fit into the external acoustic meatus and the bead protrusions 24 of the plate body 23 contact the heart acupuncture point and the lung acupuncture point.

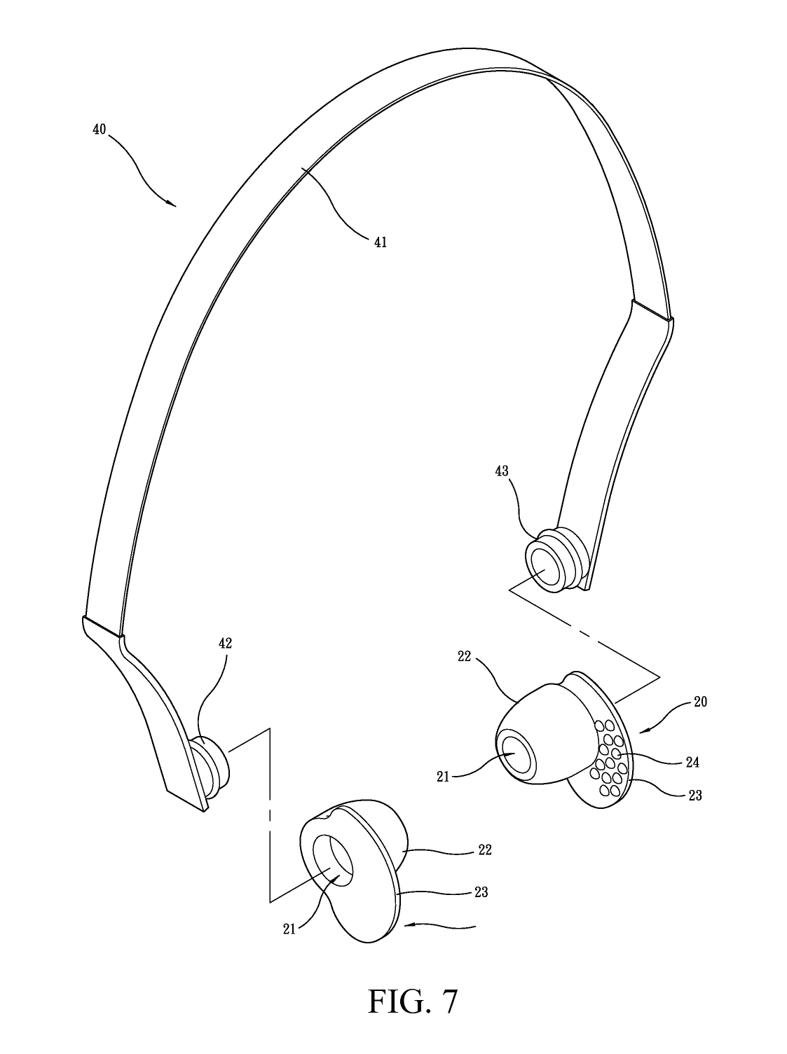

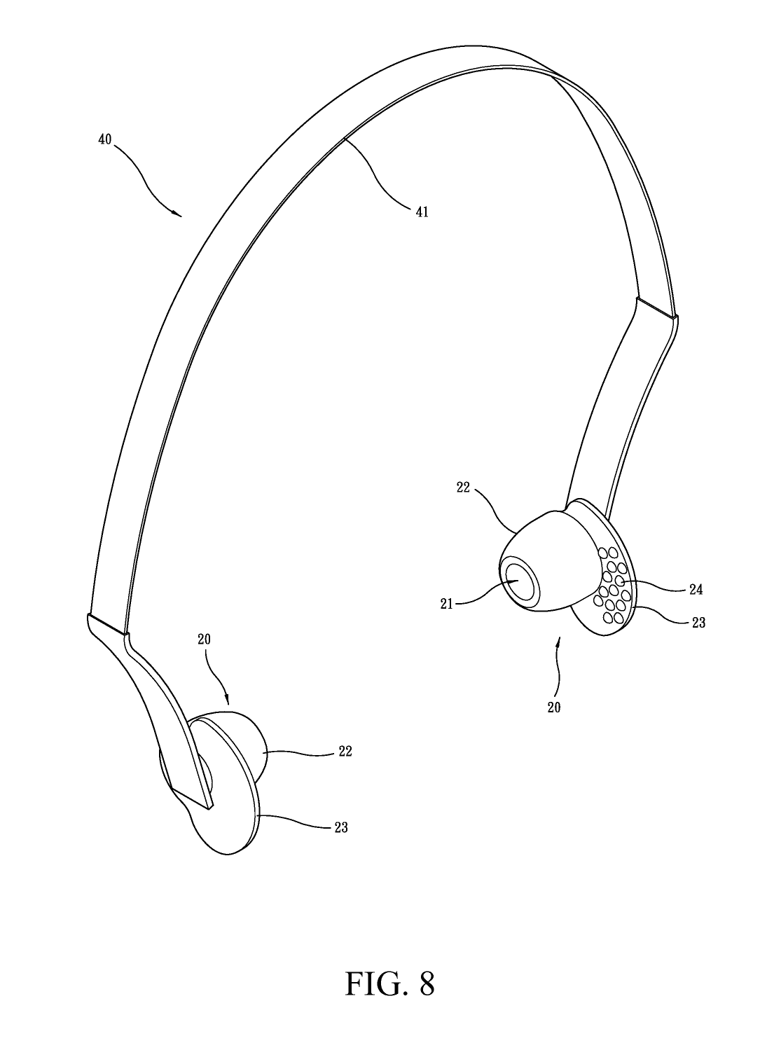

Referring to FIGS. 7 and 8, a fourth embodiment of the present invention is shown, where the auricular point stimulus device 20 is mounted to a head-wearing ear frame 40. The head-wearing hanger frame 40 comprises a head strap 41, which is in the form of an arch. The head strap 41 has two lower ends that are free ends and the two ends are spaced from each other by a distance. Each of the ends has an inside surface on which a projecting axle 42, 43 is formed. Each axle 42, 43 is insertable into the through hole 21 of a plug 22 so that the two axles 42, 43 are each coupled to an auricular point stimulus device 20 and each of the auricular point stimulus devices 20 is allowed to rotate about the axle 42, 43. The user puts the head strap 41 on the head and insert the plugs 22 of the auricular point stimulus devices 20 into the external acoustic meatuses to have the bead protrusions of the plate bodies 23 contact the heart acupuncture points and the lung acupuncture points to achieve an effect of simultaneously simulate both ears. With the supporting achieved with the head-wearing ear frame 40, the two auricular point stimulus devices 20 do not fall unexpectedly. Further the two lower free ends of the head-wearing ear frame 40 provide an effect of clamping from opposite sides to apply tender pressures to the heart acupuncture point and the lung acupuncture point, making the result of simulation bettered.

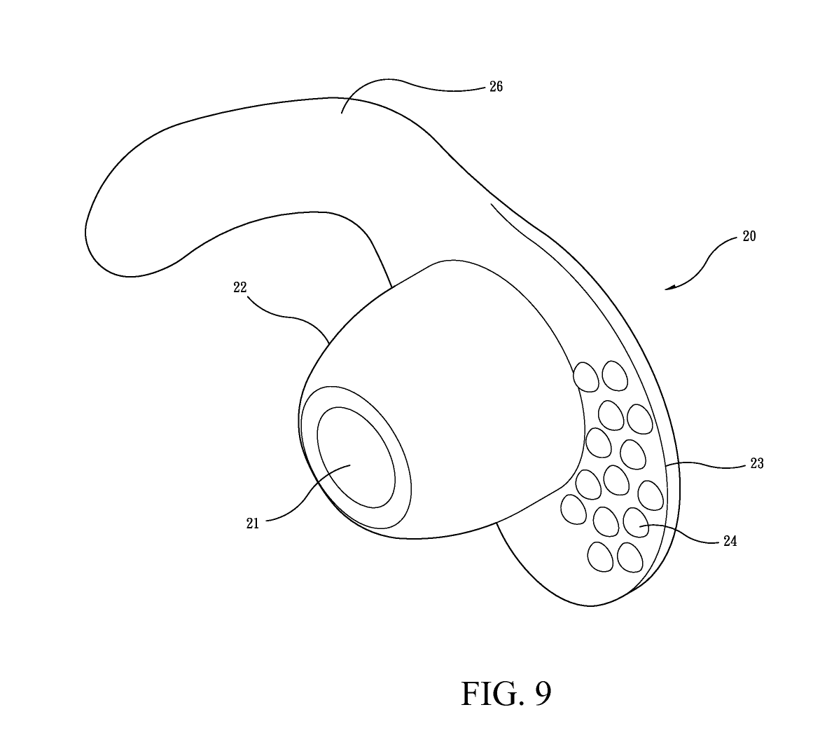

Referring to FIG. 9, a fifth embodiment of the present invention is shown, where the plate body 23 comprises a substantially arc ear clip 26 integrally formed therewith. The ear clip 26 has an inherent property for being flexible and deformable and storage of potential energy to provide an elastic reacting force. The ear clip 26 is inserted into cymba concha portion of the auricle and the plug 22 is fit into the external acoustic meatus, whereby the ear clip 26 and the plug 22 provide an effect of fixing and holding that prevents the auricular point stimulus device 20 of the instant embodiment from falling during movement or activity. The bead protrusions 24 of the plate body 23 may simulate the heart acupuncture point and the lung acupuncture point, so as to enhance the cardiorespiratory fitness of the user.

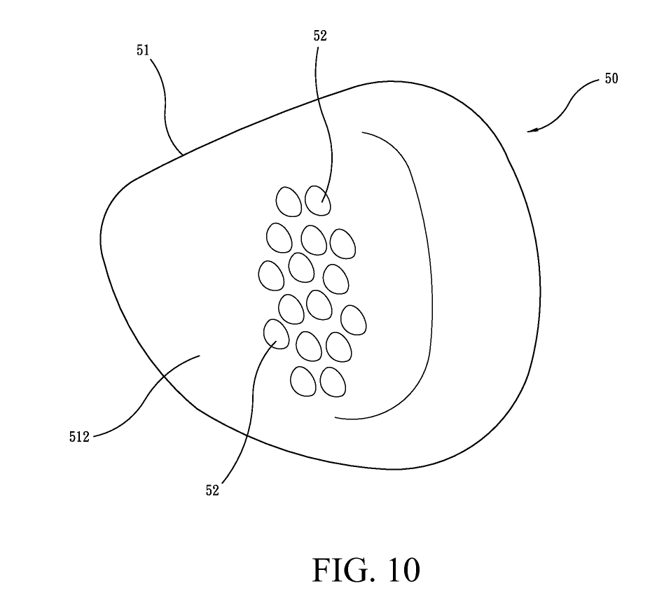

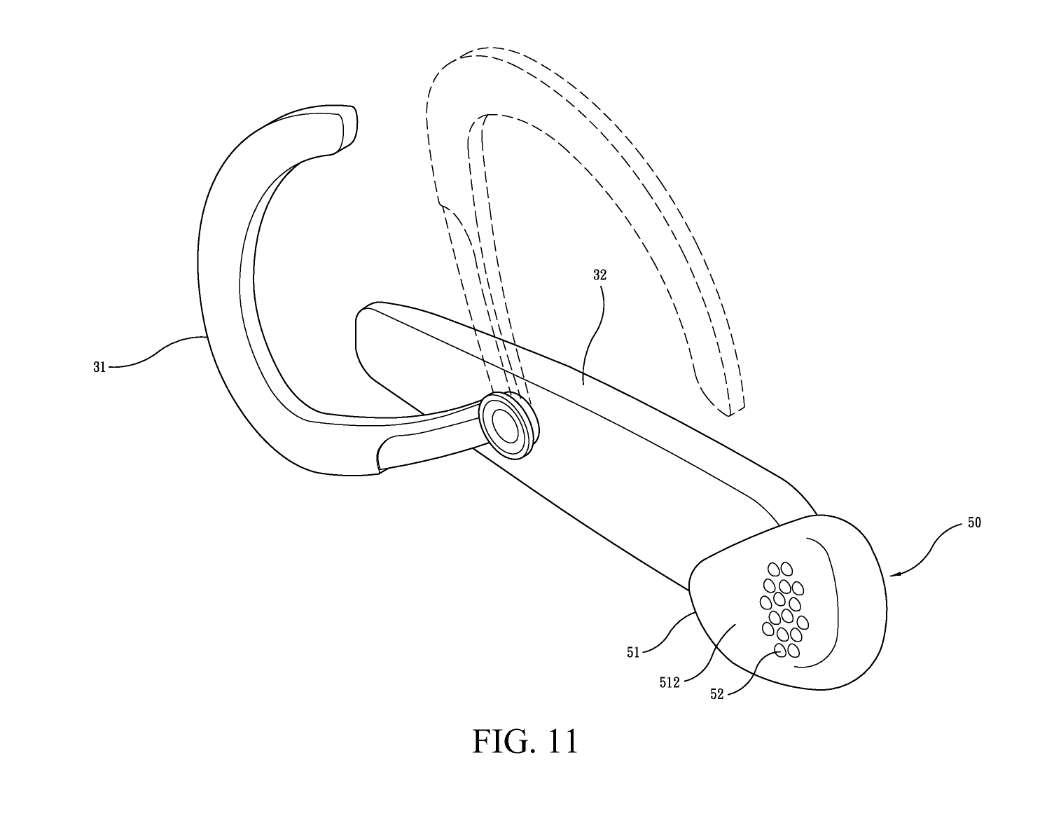

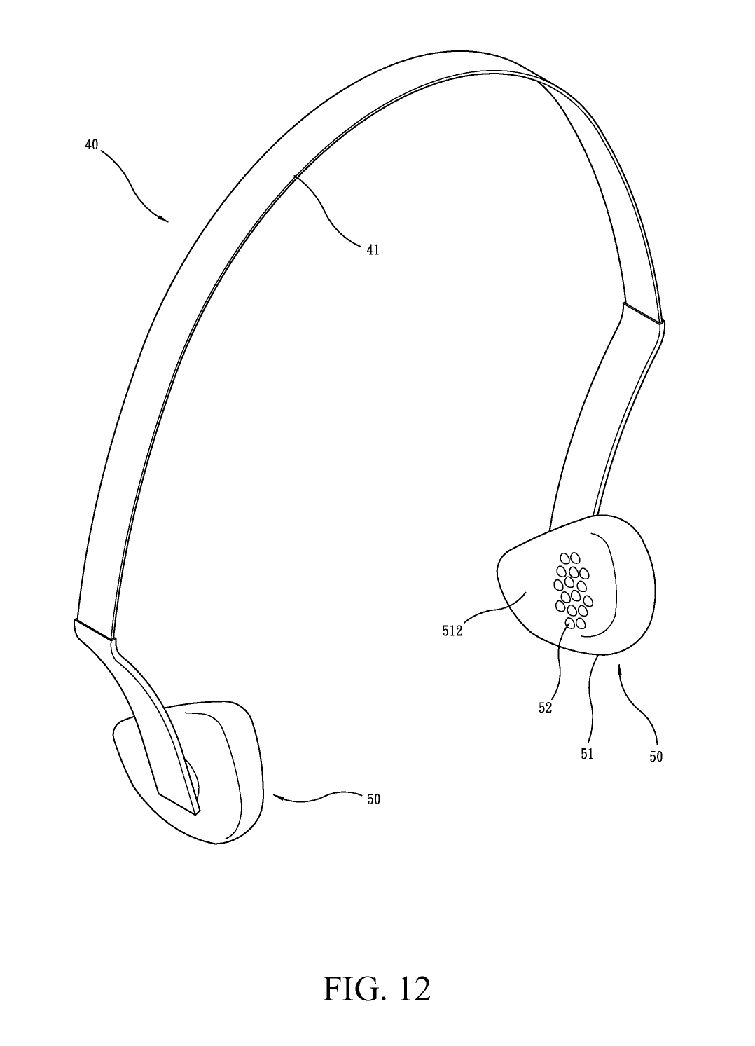

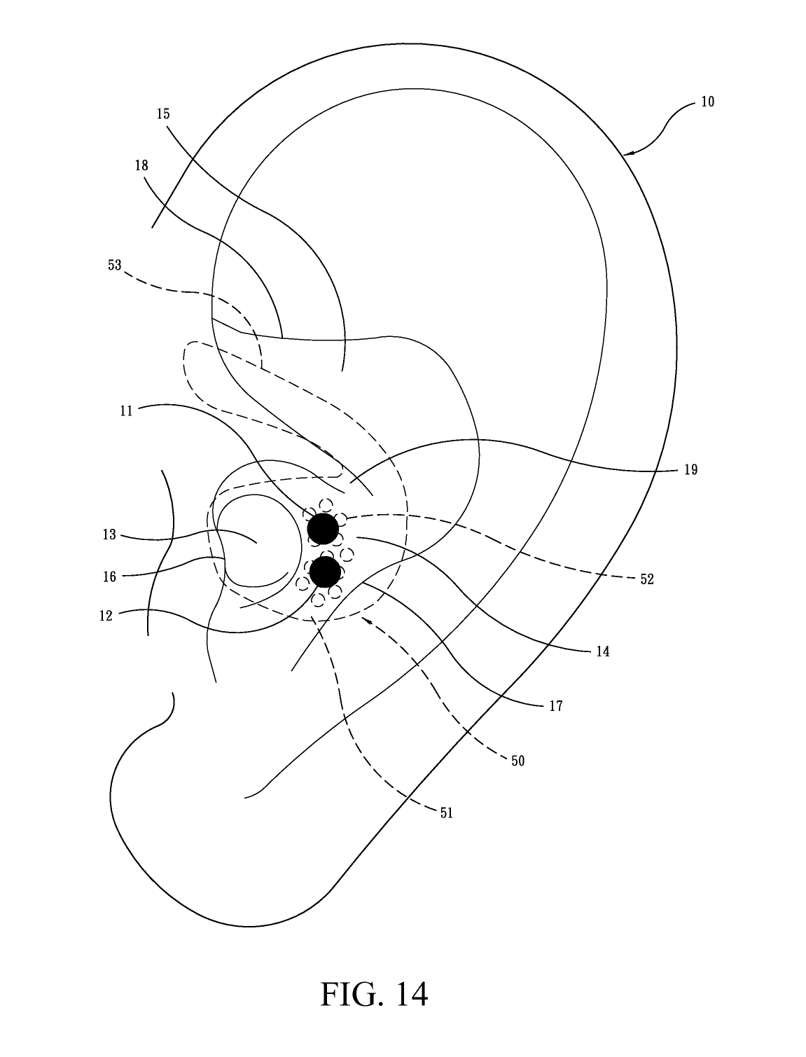

Referring to FIG. 10, which shows a sixth embodiment of the present invention, the auricular point stimulus device 50 according to the instant embodiment comprises a fan-shaped plate body 51, which has a surface having a central portion that defines a planar outside surface 512, where the outside surface is formed with a plurality of bead protrusions 52, which are made of an elastically deformable material, where the elastically deformable material may include plastics, rubbers, or silicone rubbers, and is positionable in the opening of the external acoustic meatus 13, as shown in FIG. 14, to be clamped and held in position in the external acoustic meatus 13 by the external acoustic opening 16, the anthelix 17, and the helix crus 19 of the auricle 10 with the plurality of bead protrusions 52 pressing against the heart acupuncture point 11 and the lung acupuncture point 12 to achieve stimulation of the acupuncture point 11 and the lung acupuncture point 12. Referring to FIG. 11, the auricular point stimulus device 50 according to the instant embodiment may be structured in the same way as that of the third embodiment by attaching the auricular point stimulus device 50 to a single-ear hanger frame 30 and operation and effectiveness will be similar to those of the third embodiment so that no repeated description will be given. Referring to FIG. 12, the auricular point stimulus device 50 according to the instant embodiment may also be structured in the same way as that of the fourth embodiment by attaching the auricular point stimulus device 50 to a head-wearing hanger frame 30 and operation and effectiveness will be similar to those of the third embodiment so that no repeated description will be given. Referring to FIG. 12, the auricular point stimulus device 50 according to the instant embodiment may also be structured in the same way as that of the fourth embodiment by attaching the auricular point stimulus device 50 to a head-wearing hanger frame 30 and operation and effectiveness will be similar to those of the third embodiment so that no repeated description will be given.

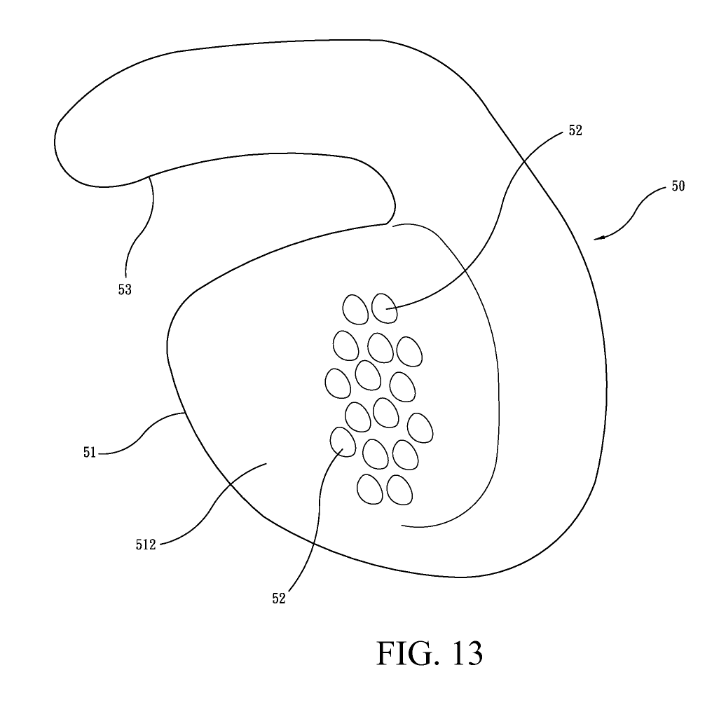

Referring to FIGS. 13 and 14, the auricular point stimulus device 50 according to the instant embodiment comprises a substantially arc ear clip 53 integrally formed with one side of the plate body 51. The ear clip 26 has an inherent property for being flexible and deformable and storage of potential energy to provide an elastic reacting force. The ear clip 53 is inserted into cymba concha 15 of the auricle 10, whereby the auricular point stimulus device 50 is subjected to secondary retention and holding so that a user, when taking exercise, may securely wear the the auricular point stimulus device 50 with falling and the bead protrusions 52 of the plate body 51 may simulate the heart acupuncture point 11 and the lung acupuncture point 12, so as to enhance the cardiorespiratory fitness of the user

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An auricular point stimulus device, which comprises at least a plate body, the plate body comprising a plurality of bead protrusions formed and distributed thereon, the plate body having a surface on which a projecting plug is formed.

2. The auricular point stimulus device according to claim 1, wherein the plug comprises a through hole extending through opposite ends thereof.

3. The auricular point stimulus device according to claim 1, wherein the plurality of the bead protrusions is mounted to an adhesive sheet and the adhesive sheet is adhesively attachable to an outside surface of the plate body.

4. The auricular point stimulus device according to claim 2, wherein the auricular point stimulus device is mounted to a single-ear hanger frame, the single-ear hanger frame comprising a substantially arc helix section and a coupling section, the coupling section having an end rotatably coupled to the helix section to allow the helix section or the coupling section to swing, the coupling section having an opposite end on which a projecting axle is formed, the axle being insertable into the through hole of the auricular point stimulus device to couple the auricular point stimulus device to the single-ear hanger frame.

5. The auricular point stimulus device according to claim 2, wherein the auricular point stimulus device is mounted to a head-wearing hanger frame, the head-wearing hanger frame comprising a head strap that is arch in shape, the head strap having two lower ends that are free ends, the two ends being spaced from each other by a distance, each of the ends having an inside surface on which a projecting axle is formed, each of the axles being insertable into the through hole of an auricular point stimulus device so that each of the two axles is coupled to an auricular point stimulus device.

6. The auricular point stimulus device according to claim 1, wherein the plug is integrally formed with an arc ear clip.

7. The auricular point stimulus device according to claim 1, which is made of an elastically deformable material, the elastically deformable material including plastics, rubbers, and silicone rubbers.

8. An auricular point stimulus device, which comprise a plate body, which has one side forming an outside surface on which a plurality of bead protrusions is formed.

9. The auricular point stimulus device according to claim 8, wherein the plate body has one surface integrally formed with an arc ear clip.

10. The auricular point stimulus device according to claim 8, wherein the auricular point stimulus device is mounted to a single-ear hanger frame, the single-ear hanger frame comprising a helix section that is substantially arc and a coupling section, the coupling section having an end rotatably mounted to the helix section so that the helix section or the coupling section is allowed to swing, the coupling section having an opposite end on which a projecting axle is formed, the axle receiving the auricular point stimulus device to combine therewith.

11. The auricular point stimulus device according to claim 8, wherein the auricular point stimulus device is mounted to a head-wearing hanger frame, the head-wearing hanger frame comprising a head strap that is arch in shape, the head strap having two lower ends that are free ends, the two ends being spaced from each other by a distance, each of the ends having an inside surface on which a projecting axle is formed, each of the axles receiving an auricular point stimulus device to combine therewith.

12. The auricular point stimulus device according to claim 8, which is made of an elastically deformable material, the elastically deformable material including plastics, rubbers, and silicone rubbers.
